(19) United States
(12) Patent Application Publication
(10) Pub. No.: US 2013/0281201 A1
(43) Pub. Date: Oct. 24, 2013

(54) VIDEO GAME CONTROL SERVER, VIDEO GAME CONTROL APPARATUS, AND VIDEO GAME CONTROL PROGRAM PRODUCT

(71) Applicant: KABUSHIKI KAISHA SQUARE ENIX (also trading as SQUARE ENIX CO., LTD.), (US)

(72) Inventor: Shingo KOSUGE, Tokyo (JP)

(73) Assignee: KABUSHIKI KAISHA SQUARE ENIX (also trading as SQUARE ENIX CO., LTD.), Tokyo (JP)

(21) Appl. No.: 13/855,231

(22) Filed: Apr. 2, 2013

(30) Foreign Application Priority Data
Apr. 20, 2012 (JP) 2012-097146

(51) Int. Cl. A63F 13/12

(52) U.S. Cl. CPC A63F 13/12
USPC 463/29

(57) ABSTRACT

A video game control server controls progress of a video game via a communication network. The video game is carried out by video game control apparatuses respectively operated by a plurality of players. Progress status information indicating a status of progress of the video game for each of the plurality of players is stored in a progress status information storer. By referring to the status of the progress of the video game for each of the plurality of players, it is determined whether the number of players who satisfy a predetermined achievement condition of the plurality of players belonging to a group reaches a predetermined number or not. A special game is caused to start in a case where the number of satisfied players reaches the predetermined number. The special game is played by the players of the predetermined number who satisfy the predetermined achievement condition.

### CROSS-REFERENCE TO RELATED APPLICATION

The present disclosure relates to subject matter contained in Japanese Patent Application No. 2012-097146, filed on Apr. 20, 2012, the disclosure of which is expressly incorporated herein by reference in its entirety.

### BACKGROUND OF THE INVENTION

1. Field of the Invention

The present invention relates to a video game control server for controlling progress of a video game, a video game control apparatus, and a video game control program product.

2. Description of the Related Art

Heretofore, as a video game (an online game or a network game) in which a plurality of players share a virtual space with each other via a network, ones in which the plurality of players are caused to belong to one group and are promoted to corporate with each other in order to achieve a certain purpose are known.

In video game control apparatuses for controlling such a video game, there is one in which various kinds of processing are carried out so that a reward share corresponding to an action of a character operated by each of the plurality of players is calculated and the calculated reward is distributed to each character belonging to a group on the basis of the reward share in a case where a condition to acquire a reward is satisfied in accordance with progress of the video game (see Japanese Patent Application Publication No. 2002-239237).

However, there has been a problem that it may be difficult to effectively promote combination and cooperation among members belonging to a group in such a video game controlled by a conventional video game control apparatus. Namely, there has been a problem that, in the case of accomplishing a given purpose with the group, for example, it is impossible to effectively promote combination and cooperation of players whose purpose of the video game is not to acquire a reward or players who do not participate in the video game aggressively even though a predetermined reward share is set up to an action of each player belonging to the group (or a player character operated by each player).

### SUMMARY OF THE INVENTION

The present invention has been made in order to solve the problems described above, and it is an object of the present invention to allow interest of a player in a video game to be improved by promoting combination and cooperation among members who belong to a group.

In order to achieve the above object, the present invention is directed to a video game control server for controlling progress of a video game via a communication network. In this case, the video game is carried out by one or more video game control apparatuses, and the one or more video game control apparatuses are respectively operated by a plurality of players. The video game control server according to the present invention includes a progress status information storer for storing progress status information, the progress status information indicating a status of progress of the video game for each of the plurality of players, the plurality of players playing the video game.

The video game control server according to the present invention also includes a group arrival determiner for determining, by referring to the status of the progress of the video game for each of the plurality of players belonging to a group, whether the number of players who satisfy a predetermined achievement condition of the plurality of players reaches a predetermined number or not.

The video game control server according to the present invention also includes a special game starter for causing a special game to start in a case where the group arrival determiner determines that the number of satisfied players reaches the predetermined number, the special game being played by players of the predetermined number who satisfy at least the predetermined achievement condition of the players belonging to the group.

By configuring the video game control server as described above, it is possible to promote combination and cooperation among members who belong to a group, and this makes it possible to improve interest of a player in a video game.

In the video game control server according to the present invention, it is preferable that the special game starter starts the special game played by all of the players who belong to the group.

In the video game control server according to the present invention, it is preferable that the video game control server further includes: a special game executor for carrying out the special game in a case where the special game starter starts the special game; a special game clear condition determiner for determining whether a clear condition of the special game carried out by the special game executor; and a privilege applier for applying a privilege to the player who plays the special game in a case where the special game clear condition determiner determines that the clear condition of the special game is satisfied, wherein, when a player who does not satisfy the predetermined achievement condition of the players who play the special game satisfies the predetermined achievement condition, the privilege applier applies the privilege to the player.

In the video game control server according to the present invention, it is preferable that the video game control server further includes: a special game executor for carrying out the special game in a case where the special game starter starts the special game; a special game clear condition determiner for determining whether the clear condition of the special game carried out by the special game executor is satisfied; and a privilege applier for applying a privilege to the player who played the special game in a case where the special game clear condition determiner determines that the clear condition of the special game is satisfied.

In the video game control server according to the present invention, it is preferable that the video game is a video game configured by stages of a specific number including a final stage; the predetermined achievement condition is a condition that is satisfied when stages of the predetermined number of the stages of the specific number are cleared; and the special game is a video game at the final stage.

Further, in another aspect of the present invention, the present invention is directed to a video game control apparatus for controlling progress of a video game. The video game control apparatus according to the present invention includes a progress status information storer for storing progress status information, the progress status information indicating a status of progress of the video game for each of a plurality of players, the plurality of players respectively playing the video game using their own video game control apparatuses.

The video game control apparatus according to the present invention includes a group arrival determiner for determining, by referring to the status of the progress of the video game for each of the plurality of players, whether the number of players who satisfy a predetermined achievement condition of the plurality of players belonging to a group reaches a predetermined number or not.

The video game control apparatus according to the present invention includes a special game starter for causing a special game to start in a case where the group arrival determiner determines that the number of satisfied players reaches the predetermined number, the special game being played by players of the predetermined number who satisfy at least the predetermined achievement condition of the players belonging to the group.

Moreover, in still another aspect of the present invention, the present invention is directed to a video game control program product for causing a computer to control progress of a video game. In this case, the computer includes a progress status information storer for storing progress status information. Further, the progress status information indicating a status of progress of the video game for each of a plurality of players, and each of the plurality of players plays the video game using his or her own video game control apparatus. The video game control program product according to the present invention causes the computer to execute steps including determining, by referring to the status of the progress of the video game for each of the plurality of players, whether the number of players who satisfy a predetermined achievement condition of the plurality of players belonging to a group reaches a predetermined number or not.

The steps also includes causing a special game to start in a case where it is determined that the number of satisfied players reaches the predetermined number in the determining, the special game being played by players of the predetermined number who satisfy at least the predetermined achievement condition of the players belonging to the group.

According to the present invention, it becomes possible to improve interest of a player in a video game by promoting combination and cooperation among members who belong to a group.

### BRIEF DESCRIPTION OF THE DRAWINGS

The foregoing and other objects, features and advantages of the present invention will become more readily apparent from the following detailed description of a preferred embodiment of the present invention that proceeds with reference to the appending drawings:

FIG. 1 is a block diagram showing an example of a configuration of a video game control system;

FIG. 2 is a block diagram showing an example of a configuration of a video game control server;

FIG. 3 is an explanatory drawing showing an example of a storage state of progress status information;

FIG. 4 is a flowchart showing an example of event managing processing;

FIG. 5 is an explanatory drawing showing an example of a group selection receiving screen;

FIG. 6 is an explanatory drawing showing an example of an event content explanation screen;

FIG. 7 is an explanatory drawing showing an example of a stage screen; and

FIG. 8 is a flowchart showing an example of special game processing.

### DETAILED DESCRIPTION OF THE INVENTION

Hereinafter, an example of one embodiment according to the present invention will be described with reference to the appending drawings.

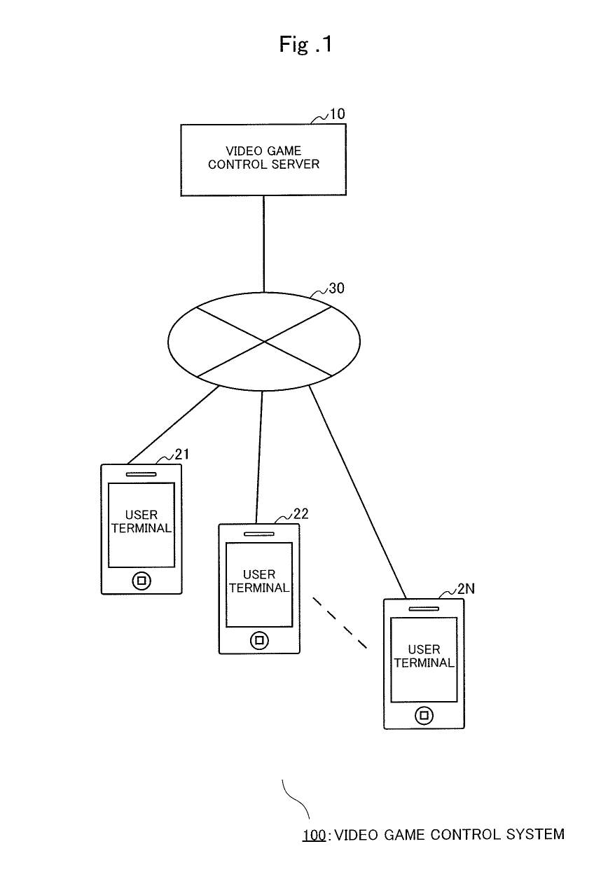

FIG. 1 is a block diagram showing an example of a configuration of a video game control system 100 according to one embodiment of the present invention. As shown in FIG. 1, the video game control system 100 includes: a video game control server 10; and video game control apparatuses (that is, user terminals) 21 to 2N (“N” is an arbitrary integer) used by a plurality of users. In this regard, the configuration of the video game control system 100 is not limited to this. The video game control system 100 may be configured so that the plurality of users uses a single user terminal. Further, the video game control system 100 may be configured so as to include a plurality of servers.

Each of the video game control server 10 and the plurality of user terminals 21 to 2N is connected to a communication network 30 such as the Internet. In this regard, although it is not shown in the drawings, each of the plurality of user terminals 21 to 2N is connected to the communication network 30 by carrying out, by a wireless communication line, data communication with a base station managed by a communication carrier.

The video game control system 100 has various kinds of functions to control a video game that is caused to proceed in response to operations of a user who operates each of the plurality of user terminals 21 to 2N.

The video game control server 10 is managed by a system manager of the video game control system 100, and has various kinds of functions to provide information on the video game to the user terminals 21 to 2N.

The video game control server 10 is configured by an information processing apparatus such as a WWW server, and includes a storage medium for storing various kinds of information. In this regard, it is preferable that the information regarding the video game is managed by the video game control server 10 in the light of the fact that a processing load on a user terminal is to be reduced in the video game control system 100. However, the video game control system 100 may be configured so that only a user terminal manages part of the information on the video game.

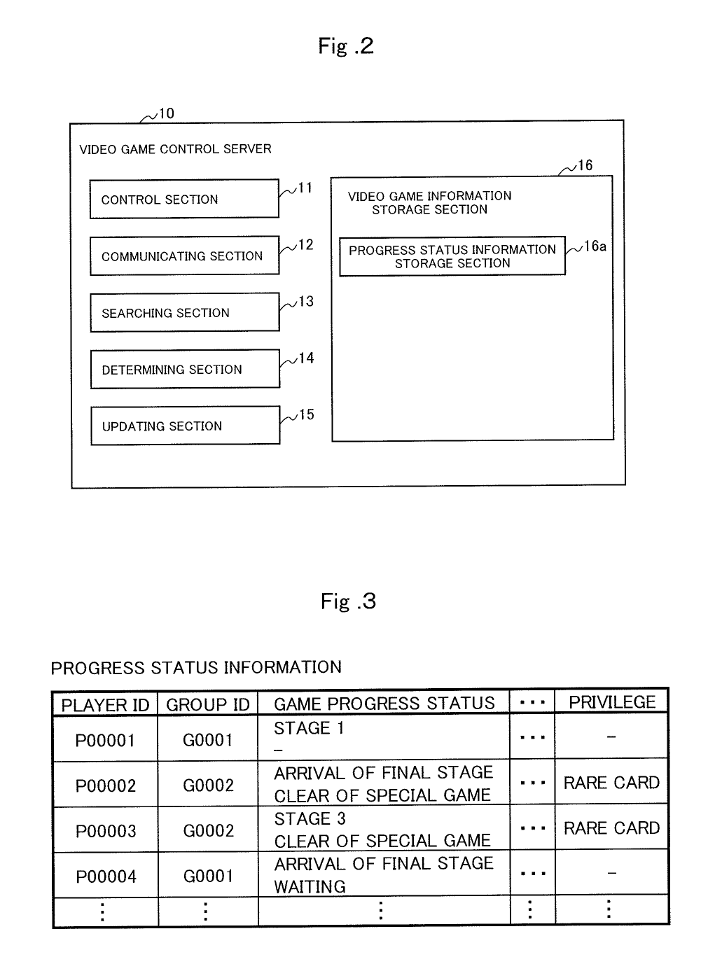

FIG. 2 is a block diagram showing an example of a configuration of the video game control server 10. As shown in FIG. 2, the video game control server 10 includes : a control section 11; a communicating section 12; a searching section 13; a determining section 14; an updating section 15; and a video game information storage section 16.

The control section 11 includes a CPU, a ROM and the like, and has a function to control the whole video game control server 10 in accordance with control programs stored in the video game information storage section 16.

The communicating section 12 has a function to carry out communication with each of the plurality of user terminals 21 to 2N via the communication network 30 such as the Internet.

The searching section 13 has a function to search for information according to progress of the video game (for example, information according to a progress status of the video game in each user terminal) from various kinds of information stored in the video game information storage section 16.

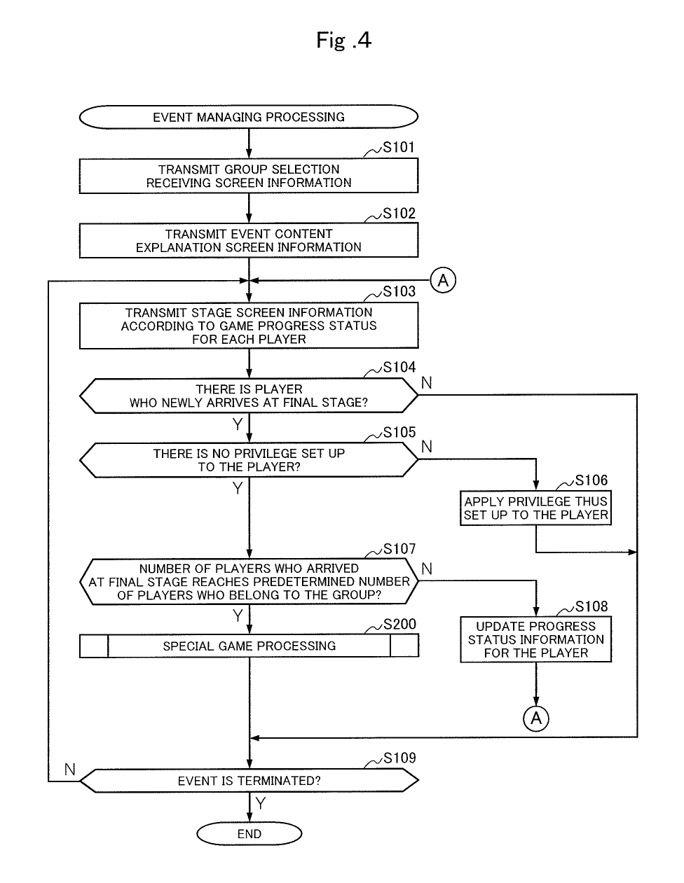

The determining section 14 has a function to carry out various kinds of determination in accordance with progress of the video game. In the present embodiment, the determining section 14 has a function to carry out various kinds of determination in an event managing processing (will be described later, see FIG. 4) on the basis of various kinds of determination conditions stored in the video game information storage section 16.

The updating section 15 has a function to update various kinds of information stored in the video game information storage section 16 in accordance with progress of the video game. In this regard, the video game control system 100 may be configured so that the information using updating processing is acquired from the plurality of user terminals 21 to 2N or is prepared in advance in the video game information storage section 16.

The video game information storage section 16 is configured by a database apparatus, for example. The video game information storage section 16 is a storage medium for storing various kinds of information on the video game whose progress is controlled by the video game control system 100 and various kinds of data such as control programs for the video game.

Here, an outline of a video game carried out by the video game control system 100 will be described. In the present embodiment, the video game control system 100 controls progress of a video game provided with three game systems, which includes: “Tohbatsu (hereinafter, referred to as a “subjugation”)” played in each of the plurality of user terminals 21 to 2N; “Kassen (hereinafter, referred to simply as a “battle”)” and “Ohtono-sen (hereinafter, referred to as a “great feudal lord battle”)” played among the plurality of user terminals 21 to 2N. Moreover, in the present embodiment, various kinds of events, hosted by a manager (or administrator) of the video game or the like, can be held, and a user is allowed to participate in the various kinds of events as part of the video game by accessing the video game control server 10.

The “subjugation” is a game system in which a physical strength value of a user is consumed and progress of a quest is controlled. In the “subjugation”, for example, processing to apply an item in the video game (hereinafter, referred to simply as the “item” appropriately), such as a virtual card used in the video game (for example, a military commander card with which image information of a military commander is associated) and a treasure box used in a “battle”, to a user with a predetermined probability in a case where the user cleared the quest is carried out. In the present embodiment, an “achievement rate”, which is calculated in accordance with an experience value and a physical strength of the user and a type of military commander card possessed by the user, is provided for the quest. In a case where the “achievement rate” reaches a predetermined percentage, “the quest is cleared”, and an experience value is applied to the user (or a virtual card used by the user, for example) or an item is provided to the user.

The “battle” is a game system in which a fight using a virtual card is controlled. In the “battle”, processing in which two users (or one user and a computer) carry out a fight using virtual cards to which various kinds of values used for the fight, such as an offensive power and a defensive power, are set up, and one user steals a treasure from the other user or loses a treasure to the other user in accordance with a result of the fight, for example, is carried out. In this regard, since a known technique may be utilized for a battle using a virtual card, a detailed explanation herein is omitted.

The “great feudal lord battle” is a game system to control a fight (or battle) in which a plurality of users forms a group (hereinafter, referred to appropriately as an “alliance”) and challenges a non-player character (hereinafter, referred to appropriately as an “Ohtono (i.e., a great feudal lord)”) to which various kinds of values (for example, a physical strength value, an offensive power value and the like) are set up to the extent that only one player cannot defeat the Ohtono. In the “great feudal lord battle”, processing in which a rarer item than one acquired by the “subjugation” is provided to the user in a case where all of the players who belong to the alliance (hereinafter, referred to appropriately as “allied members”) fully robs the great feudal lord of its physical strength is carried out, for example.

In this regard, the configuration of the video game realized by the video game control system 100 is not limited to this. For example, various kinds of game systems, including a game system (i.e., a so-called “capsule toy”) in which a user consumes a predetermined point that can be acquired in the video game (including a point acquired for free and a point acquired for a fee, for example) and a virtual card is thereby applied to the user, a game system in which a player can acquire a new virtual card by paying a predetermined point to combine a plurality of virtual cards, and the like, can be adopted.

In the present embodiment, the video game information storage section 16 includes a progress status information storage section 16a. In this regard, although it is not shown in the drawings, the video game information storage section 16 includes various kinds of storage sections for storing information necessary for controlling the progress of the video game, such as a player information storage section for storing player information that is information on players who play the video game (that is, users of respective user terminals), and a group information storage section for storing group information that is information on groups configured by a plurality of players (including player(s) that operates in accordance with a predetermined program) (in the present embodiment, the alliance).

The progress status information storage section 16a is a storage medium for storing progress status information that indicates a status of progress of the video game (i.e., a game progress status) for each player who plays the video game. In the present embodiment, the case where the progress status information indicates a status of progress (progress status) of an event by the player will be described as an example.

Here, in the present embodiment, an outline of the event whose progress status is indicated by the progress status information will be described. A holding period is provided for the event according to the present embodiment. A player who satisfies a predetermined condition during a holding period of the event is allowed to participate in the event, for example. The player to participate in the event is to select which group of a plurality of groups indicated in the event the player belongs to. The events are configured by stages of a specific number (for example, 100) including a final stage. The player captures (or clears) the respective stages from a first stage toward the final stage. When the player arrives at the final stage, the player can acquire a privilege (or a reward). In the middle of the event, a middle boss (i.e., one of enemy characters) appears on a predetermined stage (for example, every ten stages). When the player defeats the middle boss, the player is allowed to proceed to next stage. A great feudal lord (i.e., one of the enemy characters) appears before arriving at the final stage, and all of the players belonging to the group participate in the battle against the great feudal lord. In this regard, it is preferable that a physical strength of the great feudal lord is higher than that of the middle boss. A time limit is set up in the battle against the great feudal lord (the great feudal lord battle) according to the present embodiment. In a case where all of the players belonging to the group attack the great feudal lord and defeat the same within the time limit, the players who participate in the great feudal lord battle can acquire a privilege. A method of managing the events will be described in detail in explanation of event managing processing (will be described later, see FIG. 4).

FIG. 3 is an explanatory drawing showing an example of a storage state of the progress status information in the progress status information storage section 16a. As shown in FIG. 3, the progress status information contains: a player ID capable of uniquely specifying each of players; a group ID capable of uniquely specifying a group to which each player belongs; a status of progress of the video game of each player (in the present embodiment, a status of progress of an event, hereinafter, also referred to as a “game progress status”); and a privilege set up to each player.

Here, the “game progress status” indicates: a stage at which the player is positioned; and a status of implementation of a special game. The special game is played by players of the predetermined number who satisfy at least a predetermined achievement condition of a plurality of players belonging to the group. Here, in the present embodiment, in a case where ten players of the players belonging to the group arrived at the final stage, the “great feudal lord battle” is carried out as the special game. The “great feudal lord battle” is a battle against an enemy character by all of the players belonging to the same group, which also include the players who did not arrive at the final stage. Therefore, in the present embodiment, the progress status information indicates: at least a stage at which each of the players is positioned; and whether each player cleared the special game, arrived at the final stage, is in a state to wait for other players to arrive at the final stage, or has not arrived at the final stage yet.

Each of the plurality of user terminals 21 to 2N is managed by a user (or a player) who plays the video game, and is configured by a mobile communication terminal, such as a cellular phone terminal, a PDA (Personal Digital Assistants), or a mobile game device, which is allowed to play a network delivery type video game, for example. Each of the plurality of user terminals 21 to 2N includes hardware (for example, a display device for displaying a game screen, an audio output device, and the like) and software for connecting the user terminal 21 to 2N to the communication network 30 to carry out the video game by communicating with the video game control server 10. In this regard, each of the plurality of user terminals 21 to 2N may be configured so as to have a function to carry out the video game in the same virtual space as each other via the video game control server 10.

Next, an operation of the video game control server 10 according to the present embodiment will be described. In this regard, hereinafter, the case where the user terminal 21 operated by a player X of the plurality of user terminals 21 to 2N communicates with the video game control server 10 and carries out various kinds of processing will be described as an example. Further, the content of operations and processing with no relationship to the present invention may be omitted.

FIG. 4 is a flowchart showing an example of event managing processing carried out by the video game control server 10. In the event managing processing, processing to manage an event (that is, processing to cause each player to play a video game using his or her user terminal in accordance with the event content) is carried out.

The event managing processing is started in a case where the video game control server 10 determines that current date and time become the date and time when the event is to be held, for example.

In the event managing processing, the video game control server 10 first transmits, to the user terminal 21, group selection receiving screen information for causing a display device included in the user terminal 21 to display a group selection receiving screen on a display screen thereof (Step S101). In this regard, the video game control system 100 may be configured so that part or all of information regarding screens and images to be displayed on the display screen of the display device of the user terminal 21 is stored in a storage medium of the user terminal 21.

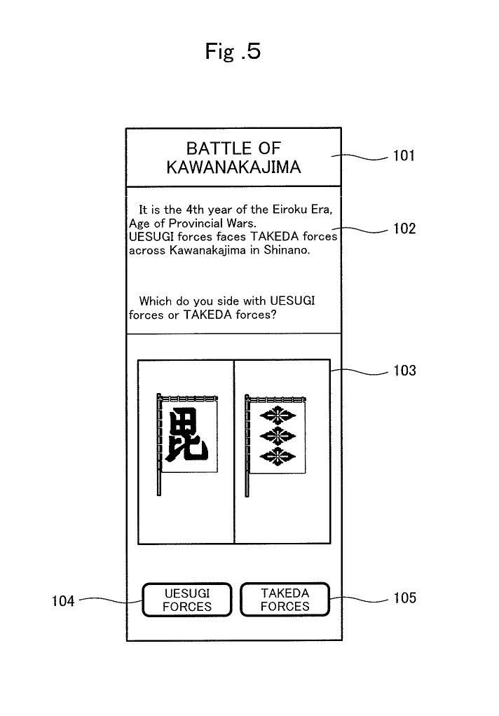

FIG. 5 is an explanatory drawing showing an example of a group selection receiving screen displayed on the display screen of the user terminal 21. As shown in FIG. 5, an event name display area 101 in which an event name of an event is displayed; an event content explanation area 102 in which an explanatory text regarding the event is displayed; a group image display area 103 in which an image indicating a group for requesting the player to select is distinguishably displayed; and two group selection buttons 104, 105 are provided on the group selection receiving screen. In the present embodiment, the case where the player is caused to select which of the two groups the player is to belong to will be described as an example. In this regard, a kind of the group to which the player belongs is not limited to this. For example, the video game control system 100 may be configured so that each player belongs to any group in advance and execution determination of a great feudal lord battle is carried out for every group to which the players belong when to start an event. Alternatively, the video game control system 100 may be configured so that each player can voluntarily call on other player for making a group after starting an event.

Subsequently, the video game control server 10 transmits, to the user terminal 21, event content explanation screen information for causing the display device included in the user terminal 21 to display an event content explanation screen on the display screen thereof (Step S102).

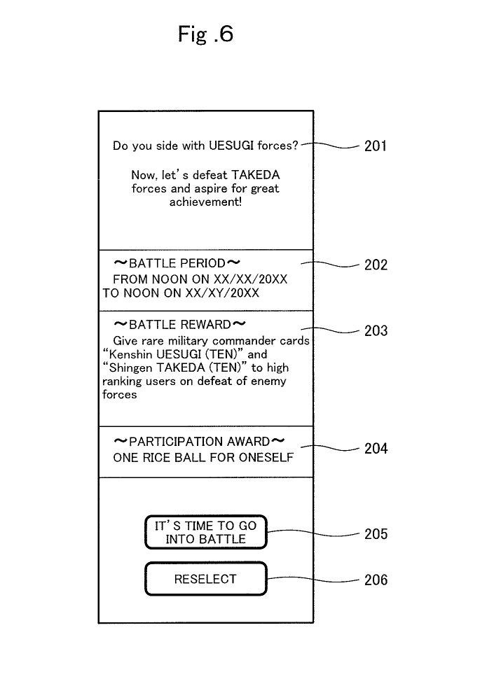

FIG. 6 is an explanatory drawing showing an example of an event content explanation screen to be displayed on the display screen of the user terminal 21. As shown in FIG. 6, an event content explanation area 201 in which the explanatory text regarding the event is displayed; an event holding period display area 202 in which an event holding period is displayed; a clear privilege display area 203 in which a privilege when to clear the event is displayed; a participation privilege display area 204 in which a privilege for participation in the event is displayed; an event start request receiving button 205 for receiving a request to start the event; and a reselection request receiving button 206 for receiving a request for reselection of the group are provided on the event content explanation screen.

For example, when the video game control server 10 receives, from the user terminal 21, notification that a selection operation to the event start request receiving button 205 is carried out, the video game control server 10 transmits, to the user terminal 21, stage screen information (Step S103). The stage screen information is used for displaying a stage screen indicating a stage according to the game progress status for the player X on the display screen of the display device included in the user terminal 21.

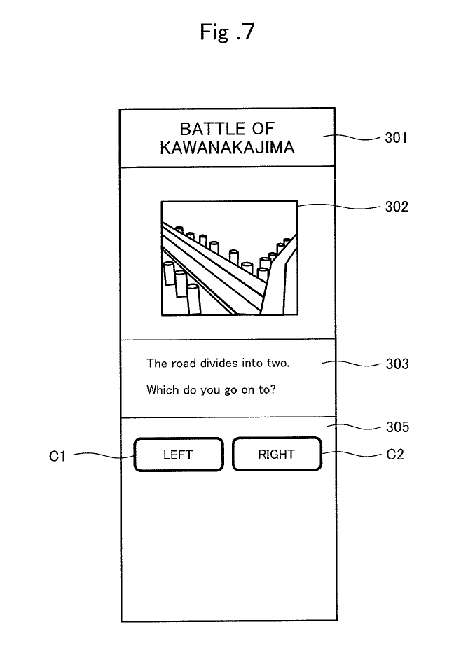

FIG. 7 is an explanatory drawing showing an example of the stage screen. As shown in FIG. 7, an event name display area 301 in which an event name of the event is displayed; a stage image display area 302 in which an image according to the stage is displayed; a stage content explanation area 303 in which the explanatory text regarding the stage is displayed; and a button display area 305 in which various kinds of buttons for causing the player X to select are displayed are provided on the stage screen. In FIG. 7, two progress direction selecting buttons C1, C2 for deciding on which way the player goes at a branching stage are displayed in the button display area 305. In this regard, a configuration of the stage screen needs not be unified by one event, and it is preferable that the stage screen is configured in accordance with the content of each stage included in the event (for example, a movement stage, a battle stage, a stage to acquire an item in the video game, and the like).

When the stage screen information is transmitted, the video game control server 10 determines whether or not there is a player who newly arrives at the final stage of the players who participate in the event (Step S104). In this regard, the video game control server 10 receives various kinds of information from the user terminals 21 to 2N operated by the players who participate in the event, whereby the progress status information stored in the progress status information storage section 16a is updated.

In a case where it is determined that there is no player who newly arrives at the final stage (for example, a player whose history is never set up as the determination target) by referring to the progress status information (“No” at Step S104), the video game control server 10 causes the processing flow to shift to a process at Step S109 (will be described later).

On the other hand, in a case where it is determined that there is a player who newly arrives at the final stage by referring to the progress status information (“Yes” at Step S104), the video game control server 10 determines whether there is no privilege set up to the player who newly arrives at the final stage or not (Step S105). Here, in a case where it is determined that there is a privilege set up to the player newly arrives at the final stage (“No” at Step S105), the video game control server 10 applies the privilege, which is set to the player, to the player (Step S106), and causes the processing flow to shift to the process at Step S109 (will be described later).

On the other hand, in a case where it is determined that there is no privilege that is set up to the player who newly arrives at the final stage (“Yes” at Step S105), the video game control server 10 determines whether the number of players who arrived at the final stage reaches a predetermined number of the players who belong to the group or not (Step S107). In the present embodiment, the video game control server 10 refers to the progress status information, and determines whether the number of players who arrived at the final stage reaches ten or more of all of the players who belong to the group, to which the player who newly arrived at the final stage. In this regard, in a case where there are plural players who newly arrives at the final stage substantially at the same time, for example, the video game control server 10 may determine whether the number of players who arrived at the final stage of the players who belong to one group reaches the predetermined number or not. For that reason, the video game control server 10 needs not determine whether the number of players exceeds the predetermined number or not. However, the video game control server 10 may naturally be configured so as to determine whether or not the number of players who arrived at the final stage reaches the predetermined number or more when to determine whether the number of players who arrived at the final stage reaches the predetermined number of the players who belong to a group or not.

Here, in a case where it is determined that the number of players does not reach the predetermined number (that is, in a case where it is determined that there is no group to which ten players who arrived at the final stage belong) (“No” at Step S107), the video game control server 10 updates the progress status information for the player (Step S108), and causes the processing flow to shift to the process at Step S103. In the present embodiment, the video game control server 10 updates the progress status information so as to be capable of recognizing that a status of the player who arrives at the final stage is a status (waiting) to wait for the players belonging to the same group to arrive at the final stage. In this regard, the video game control server 10 may be configured so that, at this time, in order for the player who is in a waiting state not to have nothing to do, a predetermined mini game is provided to a player in a waiting state, the time when to be in the waiting state is reflected to the content of a privilege, or the player in a waiting state is allowed to assist the other players belonging to the same group, for example.

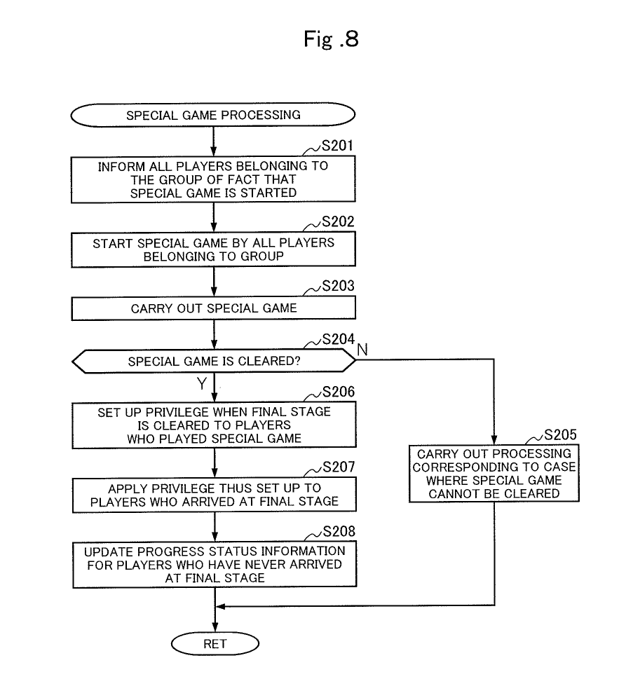

On the other hand, in a case where it is determined that the number of players reaches the predetermined number (that is, in a case where it is determined that there is a group to which ten players, who arrived at the final stage, belong) (“Yes” at Step S107), the video game control server 10 carries out processing to control progress of the special game (special game processing) (Step S200). The special game processing will be described in detail later (see FIG. 8).

When the special game processing is carried out, the video game control server 10 determines whether the event is to be terminated or not (Step S109). Here, in a case where it is determined that the event is not to be terminated, for example, because the current date and time is during the event holding period (“No” at Step S109), the video game control server 10 causes the processing flow to shift to the process at Step S103.

On the other hand, in a case where it is determined that the event is to be terminated, for example, because the current date and time passes the event holding period (“Yes” at Step S109), the video game control server 10 terminates the processing herein. In this regard, a standard to determine whether the event is to be terminated or not is not limited particularly. For example, the video game control server 10 may be configured so as to terminate the event when the number of players who terminated the special game reaches a specific number.

FIG. 8 is a flowchart showing an example of special game processing carried out by the video game control server 10. In the special game processing, processing to control progress of a special game is carried out.

In the special game processing, the video game control server 10 first informs all of the players belonging to the group for which it is determined that the number of players, who arrived at the final stage, reaches the predetermined number of the fact that the special game is to be started (Step S201). In this regard, the method of informing of that effect is not limited particularly. For example, the video game control server 10 may be configured so as to cause each of the user terminals to display a game screen for confirming whether each player have the will to participate in the special game or not. Further, the video game control server 10 may be configured so as to change a stage of each of the players who do not arrive at the final stage into the final stage temporarily without providing any information to such a player.

When the start of the special game is informed, the video game control server 10 starts the special game (in the present embodiment, the great feudal lord battle) played by all of the players who belong to the group (Step S202). In the present embodiment, the video game control server 10 starts the special game by transmitting special game screen information to the user terminal operated by each player. The special game screen information indicates a special game screen (not shown in the drawings) on which a predetermined enemy character is displayed.

When the special game is started, the video game control server 10 carries out the special game (Step S203). In the present embodiment, the video game control server 10 carries out, as the special game, a fighting game, in which each of the players launches an attack against an enemy character individually and the fighting game is cleared when all of the physical strength of the enemy character is reduced within the time limit. Since a known technique may be utilized for a method of carrying out a video game in which a plurality of players fight a common enemy using a communication network, a detailed explanation herein is omitted.

After carrying out the special game (more specifically, when a termination condition of the special game is satisfied, for example), the video game control server 10 determines whether a clear condition in the special game is satisfied or not (Step S204). In this regard, the video game control server 10 may carry out the processing at Step S204 during execution of the special game. Here, in a case where it is determined that the clear condition is not satisfied (“No” at Step S204), the video game control server 10 carries out processing corresponding to the case where the special game cannot be cleared (Step S205); terminates the special game processing; and causes the processing flow to shift to the process at Step S109 in the event managing processing (see FIG. 4). In this regard, the content of the processing corresponding to the case where the special game could not be cleared (for example, the case where an HP of the player becomes zero, the case where a time limit elapses before an HP of an enemy character becomes zero, and the like) is not particularly limited. For example, the video game control system 100 may be configured so that the player can carry out the special game again by consuming a predetermined item in the video game. Alternatively, the video game control system 100 may be configured so that a privilege according to the case where the special game cannot be cleared to each of the players.

On the other hand, in a case where it is determined that the clear condition is satisfied, for example, because an HP of the enemy character becomes zero (“Yes” at Step S204), the video game control server 10 sets up a privilege when the final stage is cleared to the player who played the special game (Step S206). In the present embodiment, the video game control server 10 updates the progress status information so that the privilege according to the content of the special game is associated with each of the players.

When the privilege is set up, the video game control server 10 refers to the progress status information, and applies the privilege thus set up to only the players who arrived at the final stage (Step S207).

Subsequently, the video game control server 10 updates the progress status information for players who have never arrived at the final stage (Step S208). Here, the video game control server 10 updates the progress status information so as to be capable of recognizing that the player cleared the final stage and the privilege has already been set up.

When the progress status information is updated, the video game control server 10 terminates the special game processing, and causes the processing flow to shift to the process at Step S109 in the event managing processing (see FIG. 4).

As explained above, in the embodiment described above, the video game control server 10 for controlling progress of the video game carried out by the video game control apparatuses (for example, the user terminals 21 to 2N) via the communication network 30 is configured so as to: include the progress status information storage section 16a for storing the progress status information, the progress status information indicating a status of progress of the video game for each of the plurality of players, the plurality of players playing the video game; refer to the status of the progress of the video game for each of the plurality of players (for example, the allied members) belonging to the group (for example, the alliance) to determine whether the number of players who satisfy a predetermined achievement condition (for example, arrival to the final stage in the event) of the plurality of players reaches a predetermined number (for example, ten) or not (for example, Step S107 in FIG. 4); and start the special game (for example, the great feudal lord battle played by all of the players belonging to the group) in a case where it is determined that the number of players reaches the predetermined number, the special game being played by players of the predetermined number who satisfy at least the predetermined achievement condition of the players belonging to the group (for example, Step S202 in FIG. 8). Therefore, it is possible to improve interest of a player in a video game by promoting combination and cooperation among the members (players) who belong to the group.

Namely, for example, even though only one player arrives at the final stage, the special game is not started and a privilege is not applied to the one player. Therefore, it is possible to expect an effect that other members belonging to the group are promoted to log in the video game frequently, an effect that an item in the video game such as a recovery item can be given to the other members, and an effect that the members in the same group can be caused to participate in the video game (i.e., the events) aggressively. This makes it possible to promote combination and cooperation among the members.

Further, in the embodiment described above, the video game control server 10 is configured so as to start the special game played by all of the players who belong to the group. Therefore, a light user, who hardly arrives at the final stage, can be caused to experience the special game, and this makes it possible to effectively promote active participation in the video game.

Further, in the embodiment described above, the video game control server 10 is configured so as to: carry out the special game in a case where the special game is started (for example, Step S203 in FIG. 8); determine whether the clear condition of the special game thus carried out is satisfied or not (Step S204); apply the privilege to the player who plays the special game in a case where it is determined that the clear condition of the special game is satisfied (Step S207); and apply the privilege to the player who does not satisfies the predetermined achievement condition of the players playing the special game (for example, players who have never arrived at the final stage, that is, players who are allowed to participate in the special game because the number of players belonging to the same group, who arrived at the final stage, becomes the predetermined number) when the predetermined achievement condition is satisfied (for example, when the player arrives at the final stage after termination of the special game processing). Therefore, the players who can play the special game before arriving at the final stage can benefit from the other members who made efforts for the video game compared with such a player, and this makes it possible to increase motivation of such a player to participate in the video game. Moreover, in a case where the special game can be cleared, it is determined that the privilege is to be applied to the players who can play the special game before arriving at the final stage when each of them arrives at the final stage. Therefore, it becomes possible to effectively motivate the players to arrive at the final stage on their own.

Further, in the embodiment described above, the video game control server 10 is configured so as to: carry out the special game in a case where the special game is started (for example, Step S203 in FIG. 8); determine whether the clear condition of the special game thus carried out is satisfied or not (Step S204); and apply the privilege to the players who played the special game in a case where it is determined that the clear condition of the special game is satisfied (Step S207). Therefore, it becomes possible to promote combination and cooperation among the participating players in order to clear the special game.

Further, in the embodiment described above, the video game control server 10 and/or the video game control system 100 are configured so that: the video game is a video game (for example, a video game in which an event configured by a plurality of stages can be held) configured by stages of the specific number (for example, 100) including a final stage; the predetermined achievement condition is a condition that is satisfied when stages of the predetermined number (for example, the stages other than the final stage, i.e., 99 stages) of the stages of the specific number are cleared; and the special game is a video game at the final stage. Therefore, it is possible to adjust the time necessary for clearing one stage, for example. Further, the video game control server 10 may be configured so that, in a case where there is a player who is playing any stage in the same group when to start the special game, the special game is not to be started until the play of the stage by the player is terminated regardless of success or failure. In this case, it is possible to heighten flexibility of a design of the video game. For example, it is possible to design the video game so that the time necessary to play one stage becomes shorter.

Further, in the embodiment described above, the plurality of user terminals 21 to 2N and the video game control server 10 carry out various kinds of processing described above in accordance with various kinds of control programs (for example, a video game control program product) stored in the respective storage devices.

Further, the video game control system 100 may be configured so that a part or all of the functions included in any one of the user terminal 21 and the video game control server 10 in the video game control system 100 are included in the other one.

### INDUSTRIAL APPLICABILITY

The present invention is useful to provide a video game in which it becomes possible to improve interest of a player in a video game by promoting combination and cooperation among members who belong to a group.

What is claimed is:

1. A video game control server for controlling progress of a video game via a communication network, the video game being carried out by one or more video game control apparatuses, the one or more video game control apparatuses being respectively operated by a plurality of players, the video game control server comprising:
a progress status information storer for storing progress status information, the progress status information indicating a status of progress of the video game for each of the plurality of players, the plurality of players playing the video game;
a group arrival determiner for determining, by referring to the status of the progress of the video game for each of the plurality of players belonging to a group, whether the number of players who satisfy a predetermined achievement condition of the plurality of players reaches a predetermined number or not; and
a special game starter for causing a special game to start in a case where the group arrival determiner determines that the number of satisfied players reaches the predetermined number, the special game being played by players of the predetermined number who satisfy at least the predetermined achievement condition of the players belonging to the group.

2. The video game control server according to claim 1, wherein the special game starter starts the special game played by all of the players who belong to the group.

3. The video game control server according to claim 2, further comprising:
a special game executor for carrying out the special game in a case where the special game starter starts the special game;
a special game clear condition determiner for determining whether a clear condition of the special game carried out by the special game executor; and
a privilege applier for applying a privilege to the player who plays the special game in a case where the special game clear condition determiner determines that the clear condition of the special game is satisfied,
wherein, when a player who does not satisfy the predetermined achievement condition of the players who play the special game satisfies the predetermined achievement condition, the privilege applier applies the privilege to the player.

4. The video game control server according to claim 1, further comprising:
a special game executor for carrying out the special game in a case where the special game starter starts the special game;
a special game clear condition determiner for determining whether the clear condition of the special game carried out by the special game executor is satisfied; and
a privilege applier for applying a privilege to the player who played the special game in a case where the special game clear condition determiner determines that the clear condition of the special game is satisfied.

5. The video game control server according to claim 1, wherein the video game is a video game configured by stages of a specific number including a final stage,
wherein the predetermined achievement condition is a condition that is satisfied when stages of the predetermined number of the stages of the specific number are cleared, and
wherein the special game is a video game at the final stage.

6. A video game control apparatus for controlling progress of a video game, comprising:
a progress status information storer for storing progress status information, the progress status information indicating a status of progress of the video game for each of a plurality of players, the plurality of players respectively playing the video game using their own video game control apparatuses;
a group arrival determiner for determining, by referring to the status of the progress of the video game for each of the plurality of players, whether the number of players who satisfy a predetermined achievement condition of the plurality of players belonging to a group reaches a predetermined number or not; and
a special game starter for causing a special game to start in a case where the group arrival determiner determines that the number of satisfied players reaches the predetermined number, the special game being played by players of the predetermined number who satisfy at least the predetermined achievement condition of the players belonging to the group.

7. A video game control program product for causing a computer to control progress of a video game, the computer comprising a progress status information storer for storing progress status information, the progress status information indicating a status of progress of the video game for each of a plurality of players, each of the plurality of players playing the video game using his or her own video game control apparatus, the video game control program product causing the computer to execute:
determining, by referring to the status of the progress of the video game for each of the plurality of players, whether the number of players who satisfy a predetermined achievement condition of the plurality of players belonging to a group reaches a predetermined number or not; and
causing a special game to start in a case where it is determined that the number of satisfied players reaches the predetermined number in the determining, the special game being played by players of the predetermined number who satisfy at least the predetermined achievement condition of the players belonging to the group.
